(19) United States
(12) Patent Application Publication
(10) Pub. No.: US 2006/0031160 A1
(43) Pub. Date: Feb. 9, 2006

(54) Method of automated monetary transfers

(76) Inventor: Edgar Villa, San Jacinto, CA (US)

Correspondence Address: GENE SCOTT; PATENT LAW & VENTURE GROUP, 3140 RED HILL AVENUE, SUITE 150, COSTA MESA, CA, 92626-3440, US

(21) Appl. No.: 10/911,041

(22) Filed: Aug. 3, 2004

(51) Int. Cl. G06Q 40/00

(52) U.S. Cl. 705/44

(57) ABSTRACT

A consumer banking method provides for establishment of a petty cash account that may have funds transferred into it by a first user using a first account number and PIN number, and also have funds transferred out of the petty cash account by a second user using a second account number and PIN number. Methods for accomplishing this are defined using telephonic and personal contact with an automated banking system.

### BACKGROUND OF THE INVENTION

1. Related Applications

None

2. Incorporation by Reference

Applicant(s) hereby incorporate herein by reference, any and all U. S. patents and U.S. patent applications cited or referred to in this application.

3. Field of the Invention

This invention relates generally to automated banking methods and more particularly to a method for automated money transfers from one user to another user without paying transfer fees.

4. Description of Related Art

The following art defines the present state of this field:

Bocinsky, Jr., U.S. Pat. No. 5,371,797: A secure electronics funds or other financial transaction system that provides substantially equivalent security to that obtained by the use of secure point of sale terminals such as automatic teller machines, yet is conducted from unsecure terminal devices such as telephones, is disclosed. A customer registers himself or herself personally, together with information on his or her bank account at a secure transaction processor. A secure terminal is used to generate an encrypted version of a personal identification number (PIN) and provides the encrypted PIN and to the secure transaction processor. The encryption key used during encryption of the PIN is also acquired from either a specific request to, or monitoring data passing from a conventional network security transaction processor. The encrypted PIN is parsed with one portion being stored in the customer record at the secure transaction processor and the other being partially masked and provided back to the customer as an access code. Upon conducting a transaction, the customer provides the access code, which is unmasked and concatenated with second portion to recreate the original full encrypted PIN. This, together with the encryption key used for the original encryption is provided to conventional security and transaction processing apparatus for regional banking networks to seek authorization for the transaction.

Marcous et al., U.S. Pat. No. 5,650,604: A system and method for fully automated electronic transfer of cash or cash equivalent between a sender and a recipient is shown, including an initiating terminal for receiving a designation of an amount of money to be electronically transferred, an account from which it is to be transferred, and a security code from the sender, a central terminal for storing the amount and the security code in a file in the central terminal, and a dispensing terminal for receiving from the recipient an entry corresponding to the designated amount of money to be transferred and the security code, for providing the entered amount of money and security code to the central terminal for comparison with the information stored in the central terminal's file, and for dispensing to the recipient funds equivalent to the designated amount of money without requiring the recipient to have a card to activate the dispensing terminal.

Downing et al., U.S. Pat. No. 5,963,647: Disclosed is a system and method for transferring funds. The invention supports funds transfers from a source account to a cash access file which can be accessed virtually twenty-four hours a day by both customers and non-customers. Access is achieved by the recipient entering a codeword selected by the sender, along with a transaction code randomly generated by the system. Once the sender provides the codeword and the transaction code to the recipient, the recipient can receive transferred cash through an ATM, even without using a card to access the system. Cash may be transferred across international borders and dispensed in a currency different than that of the sender's source account. Although cash is made available to a recipient virtually as soon as the requested transfer is approved and confirmed by the sender, the sender's account is not debited until the cash is actually received by the recipient. Other features, including security, cancellation, and status inquiries are also described.

Amos, U.S. Pat. No. 6,554,184: Instant Money-Automatic Transfer Machine system (Aunty IM) is a multiplicity of devices on a communications network available 24 hours a day, as sender, receiver and dispenser of finds interchangeably. The Aunty IM accepts standard currancy for deposit amounts or fees charged to transfer to another such reciever/dispenser device. The Sender starts a pending transaction transfer by indicating which device pays for the transfer (Sender, device A, or Dispenser, device B), to whom and where the funds are to be made available to device(s) B.sub.1-n. The amount is fed into currency acceptor at device A and a receipt is generated by the Sender, device A. A Receiver becomes a Dispenser only when the Receiver retrieves the pending transaction from device A using a verifiable password or identification. The cash is dispensed. The fee is charged at either end of the transaction.

Huberman, U.S. 20030028485: A system and method for data transaction is disclosed. The method of the present invention includes the steps of: receiving an ATM card or a telephone call from a user; providing secure access to a data file containing data items previously input by the user; selecting a data item, in response to a command from the user; and outputting the selected data item to the user. Within the system of the present invention: a data network interface, receives an Automated Teller Machine (ATM) card from a user, or a telephone call from a user; an identity authentication module authenticates the ATM card or the telephone call, and the user; a transaction management module provides secure access to a data file containing data items previously input by the user; and a data file repository stores the data file.

Sesek, U.S. 2003/0088614: A check drafted upon an account with a financial institution is generated from an ATM interface. A unique identifier is discovered for the account. Either the unique identifier or account information encoded on a magnetic strip is read. If the account information is read, the unique identifier is retrieved from a database of account information. Authorization to draft the check on the account is verified. A destination printer is identified for printed the check. An electronic representation of the check is formatted for the destination printer. The electronic representation of the check includes a check template and the unique identifier for the account. The electronic representation of the check is sent to the destination printer. The electronic representation of the check is printed from the destination printer.

Drummond et al., U.S. 2003/0126084: An application service provider (ASP) and automated transaction machine method and system is provided. The method includes providing a plurality of individually accessible server side ATM applications through at least one ASP server. The method further includes enabling a plurality of ATMs to selectively access each server side ATM application through communication with the at least one ASP server. The method also includes performing services for the ATMs with the at least one ASP server responsive to the plurality of server side ATM applications.

Dunn et al., U.S. 2004/0039694: The present invention provides a system and method for facilitating a subsidiary account with parental control of one or more spending limits. An exemplary system facilitates provision of funds to a subsidiary and control of the spending of subsidiary by a parent through establishment or modification of one or more spending limits. Exemplary spending limits may be configured for modifying a spending capacity so as to affect, for example, amount per transaction, per day, during a predetermined time period, at a particular merchant, at a particular chain of merchants, at a type of industry, in accordance with a predetermined rate of increase or decrease over time, number of transactions during any time period and/or any combination thereof. A parent may establish or modify one or more spending limits through suitable communication means such as telephone, pager, computer, digital communications device, television, personal digital assistant, facsimile machine, or other suitable device.

Our prior art search with abstracts described above teaches: a secure electronic funds transfer from telephone or unsecured terminal, a system and method for electronic transfer of funds using an automated teller machine to dispense the transferred funds, a method and system for transferring funds from an account to an individual, an automatic instant money transfer machine, a method of payroll access, a system and method for providing convenient global access to and storage of personal and business information, a card based transfer account, an automated teller machine check printing, a method and apparatus for facilitating monetary and commercial transactions, an application service provider and automated transaction machine system and method, a system and method for facilitating a subsidiary card account with controlled spending capability. However, the prior art fails to teach a set of plural accounts accessible by at least two PINs wherein at least one account, serving as a funds source account is accessible only to one of the PINs while a second account serving as a funds distribution account is accessible to either both or to only a second PIN. The present invention fulfills these needs and provides further related advantages as described in the following summary.

### SUMMARY OF THE INVENTION

The present invention teaches certain benefits in construction and use which give rise to the objectives described below.

A banking method comprises the steps of associating a first PIN with a first user; providing the first PIN with full access to a first bank account, and a second bank account; identifying the first PIN to a first automated banking attendant; transferring a first sum of money from the first bank account to the second bank account under the control of the first PIN; associating a second PIN with a second user; providing the second PIN with access to the second bank account for withdrawals only; identifying the second PIN to a second automated banking attendant; and transferring a second sum of money, wherein the second sum of money is equal to or less than the first sum of money, from the second bank account to the second user.

A primary objective of one embodiment of the present invention is to provide an apparatus and method of use of such apparatus that yields advantages not taught by the prior art.

Another objective is to provide an invention method for transfer of funds between two bank users when one is a donor and the other is a recipient and control of the flow of funds to the receipient is required by the donor.

A further objective is to conduct such finds transfers in a fully automated and secure manner.

Other features and advantages of the embodiments of the present invention will become apparent from the following more detailed description, taken in conjunction with the accompanying drawings, which illustrate, by way of example, the principles of at least one of the possible embodiments of the invention.

### BRIEF DESCRIPTION OF THE DRAWINGS

The accompanying drawings illustrate at least one of the best mode embodiments of the present invention. In such drawings:

FIGS. 1A, 1B and 1C are a continuing logical flow diagram of a method of the invention for telephonic transfer of funds between bank accounts and especially from a saving, checking or credit line account of one party to a petty cash account for use of a second party;

FIGS. 2A, 2B and 2C are a continuing logical flow diagram of an alternate method of the invention for personal transfer of funds between bank accounts and especially from the saving, checking or credit line account of the first party to the petty cash account for use of the second party; and

FIGS. 3A and 3B are a continuing logical flow diagram of a method of the invention for personal acquisition of cash from the petty cash account described in the foregoing FIGS. 1A-1C and 2A-2C.

### DETAILED DESCRIPTION OF THE INVENTION

The above described drawing figures illustrate the present invention in at least one of its preferred, best mode embodiments, which is further defined in detail in the following description. Those having ordinary skill in the art may be able to make alterations and modifications in the present invention without departing from its spirit and scope. Therefore, it must be understood that the illustrated embodiments have been set forth only for the purposes of example and that they should not be taken as limiting the invention as defined in the following.

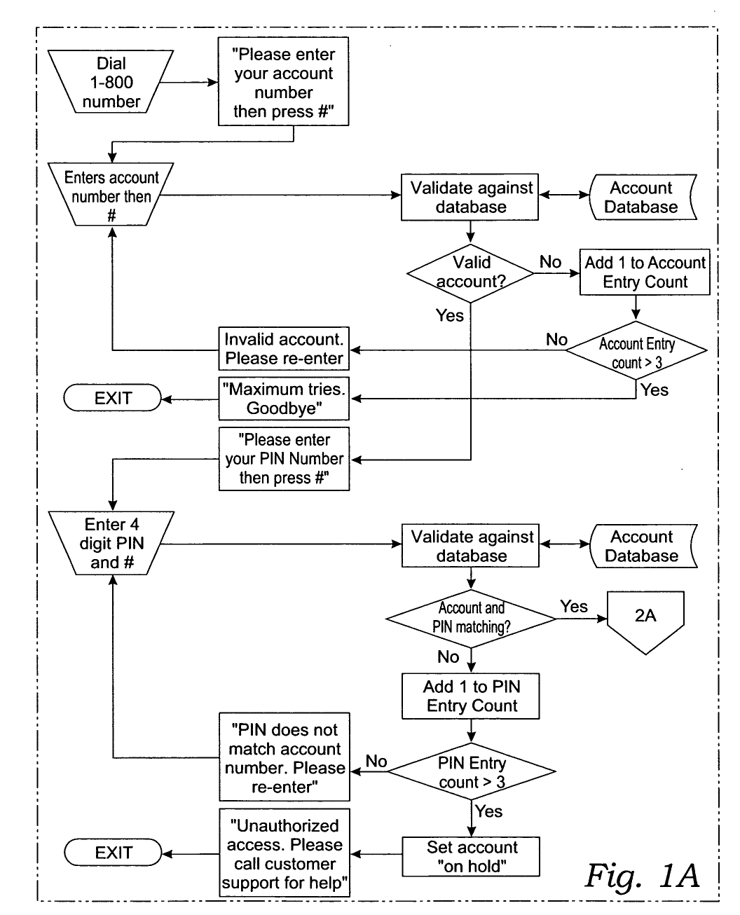

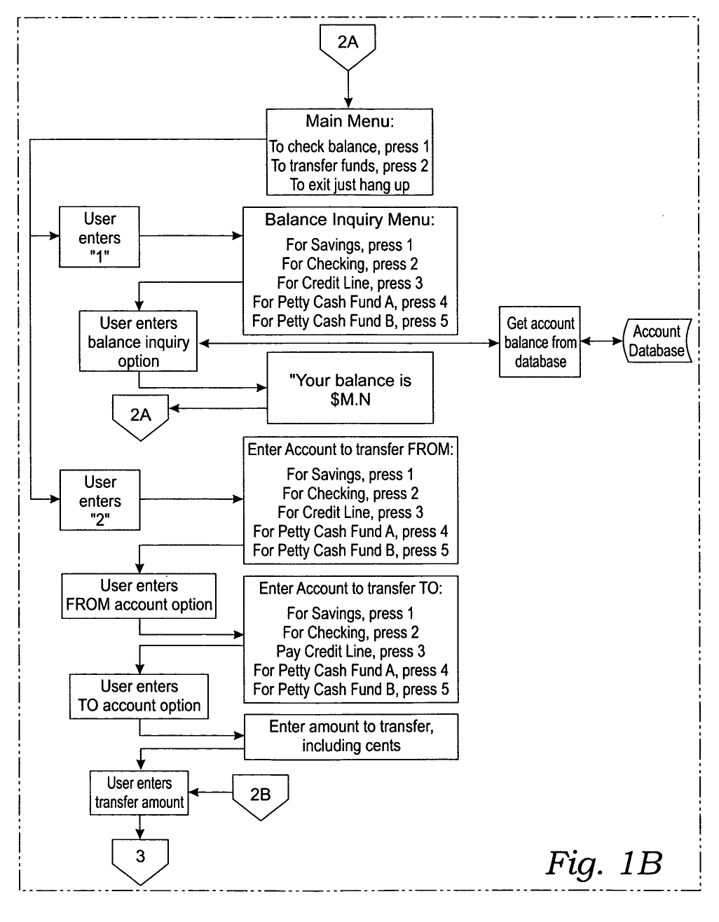

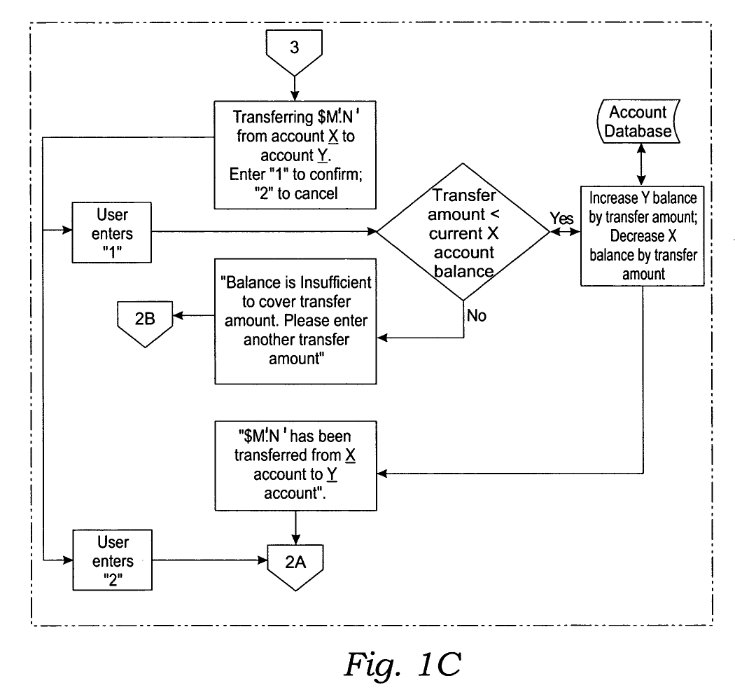

In a best mode first embodiment of a first portion of the present invention banking transactions are conducted by telephone, and both land line connected phone systems may be used as well as wireless phone systems. In this embodiment, as shown in FIGS. 1A-1C, a first user dials an 800 phone number and is connected to a programmed answering and control machine (CM) which responds audibly so that the user hears in his telephone handset, “Please enter your account number; then press pound.” The user follows this direction and the CM validates input against an account database. If valid the user hears, “Please enter your PIN number; then press pound.” The user follows this direction and the CM again checks it against the database. If valid, the user hears a main menu comprising, “Press 1 for balance information, or 2 to transfer funds, or just hang up to end this call.” If user enters a 1, the user hears, “For savings press 1, checking press 2, credit line press 3, petty cash from fund A, press 4, and for fund B, press 5.” Other alternatives may be given depending on the number of accounts that are available for the user. Upon pressing one of the alternative numeral keys, the user hears, “Your balance is $M.N cents,” where “M” and “N” represent dollars and cents respectively.

Alternatively, if the user enters a 2, the user hears, “Enter an account to transfer from . . . ” and then the same alternatives are presented as above. The user selects an account, represented in the figures as account X. After responding, the user hears, “Enter an account to transfer to . . . ” and then the same alternatives as previously. The user selects an account represented in the figures as account Y. Next, the user hears, “Enter an amount to transfer including cents.” User responds by keying in an amount represented in the figures as $M′.N′. The user then hears, “Transferring M′ dollars and N′ cents from account X to account Y; please confirm by pressing 1; or press 2 to cancel.” If the user enters a 1 the CM immediately attempts to transfer the requested amount within the account database. However, if $M′.N′ exceeds $M.N the user hears, “There is insufficient funds to make this transfer; no transfer has been made. Please enter an amount to transfer now.” This cycle continues until $M′.N′ is equal to or less than $M.N. The X and Y accounts are then adjusted by the transferred amount. The user then hears, “The amount of M′ dollars and N′ cents has been transferred from account X to account Y.” The user then hears the same main menu message as previously, and may hang up or conduct a further transaction in the same manner as above. FIG. 1A also defines a preliminary logic portion that allows the user to attempt entry into the system three times before the user is rejected and the CM hangs up. The number of trials is arbitrary and may be a number different from 3. It is noted that between the FIGS. 1A-1C a pentagon is used to refer one portion of the diagram to another so that a pentagon with a numeral 3 in it is referred to another pentagon with a numeral 3 therein as a continuation and connection between the several drawing sheets.

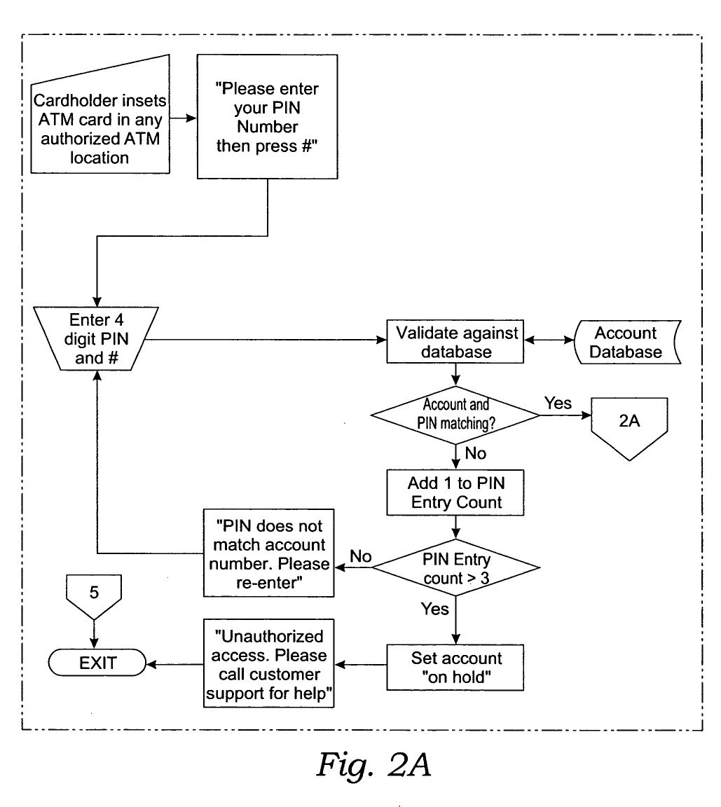

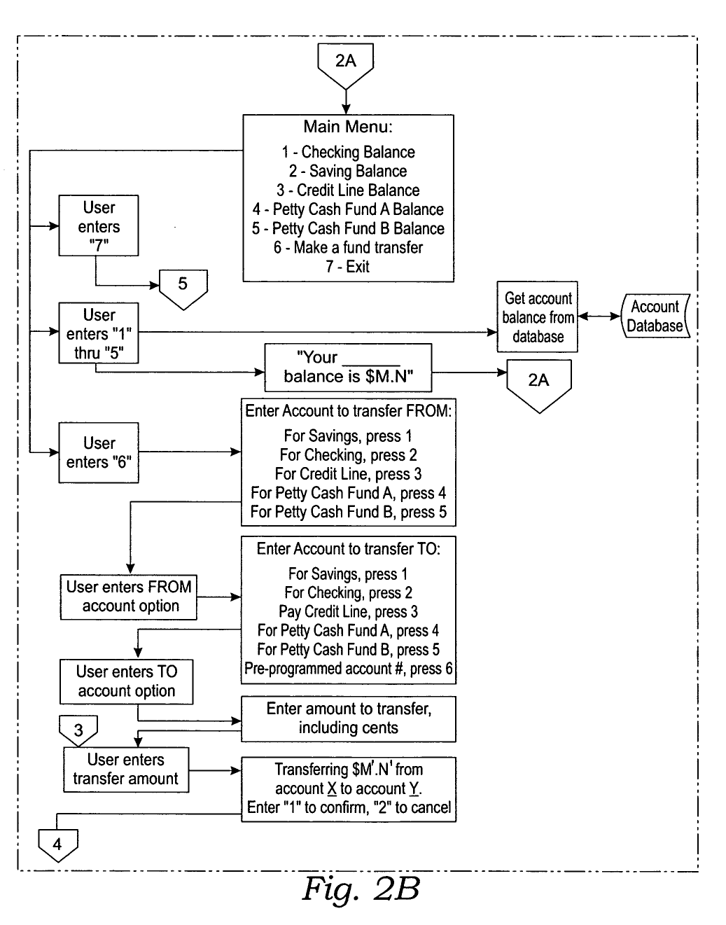

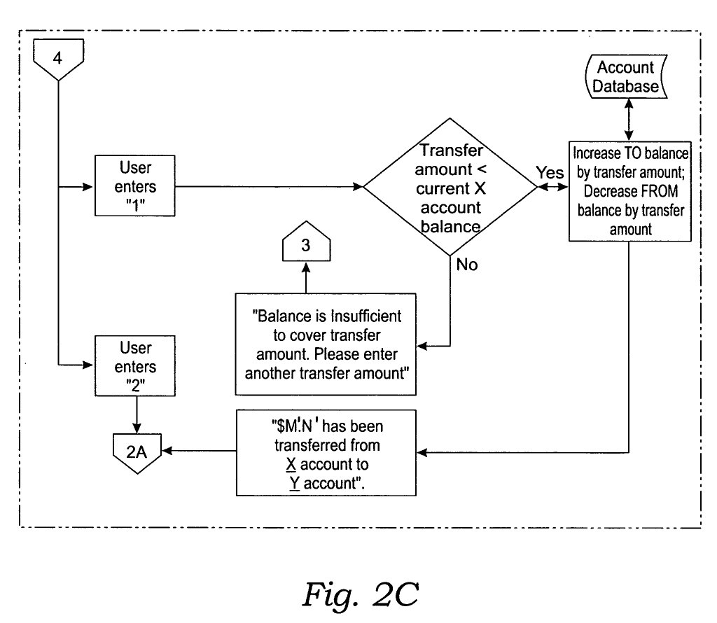

Clearly, the above described method is not limited to being conducted only telephonically, but rather this method is easily conducted in person at an ATM machine. In this embodiment, as shown in FIGS. 2A-2C, a user inserts an ATM card and is then conducted through the several steps defined above with the difference being that the user is able to view the CM's responses on a video screen of the ATM. The user is identified by the ATM card and then keys-in the PIN number. Qualification is identical to the steps taken for the telephonic method described above. Because telephones, especially cellular phones, today provide the convenience of a video screen, the method of FIGS. 2A-2C may be carried out in a hybrid of the telephonic approach first described above, and the ATM personal approach discussed in this paragraph. With the exception of being able to feed an ATM card into an ATM machine, the user may conduct banking business in accordance with this invention telephonically by referring to CM responses printed on a video screen of a telephone. Wherein the video screen of the ATM may be “touch-sense,” the phone screen usually is not, so that user responses may be limited to pressing keys on the numeric keypad of the phone.

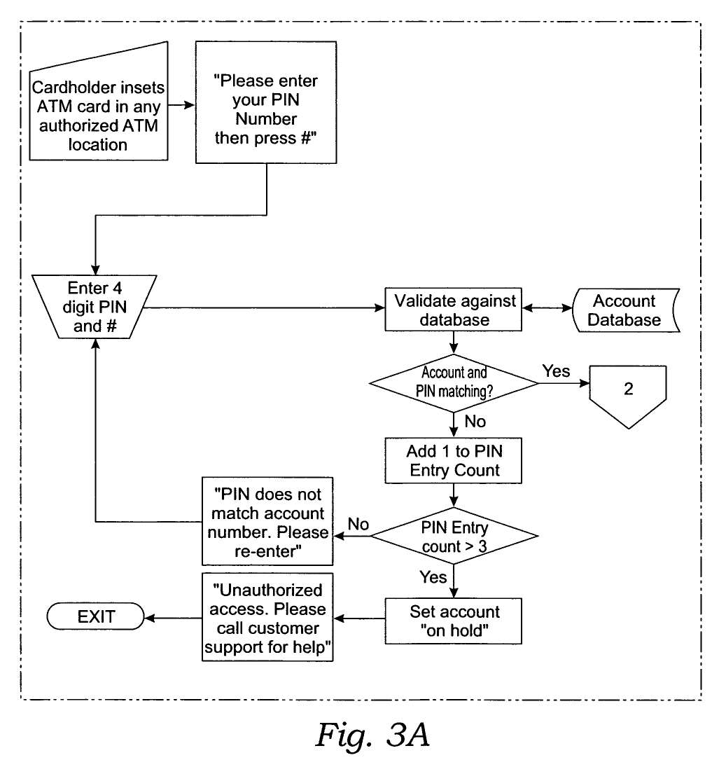

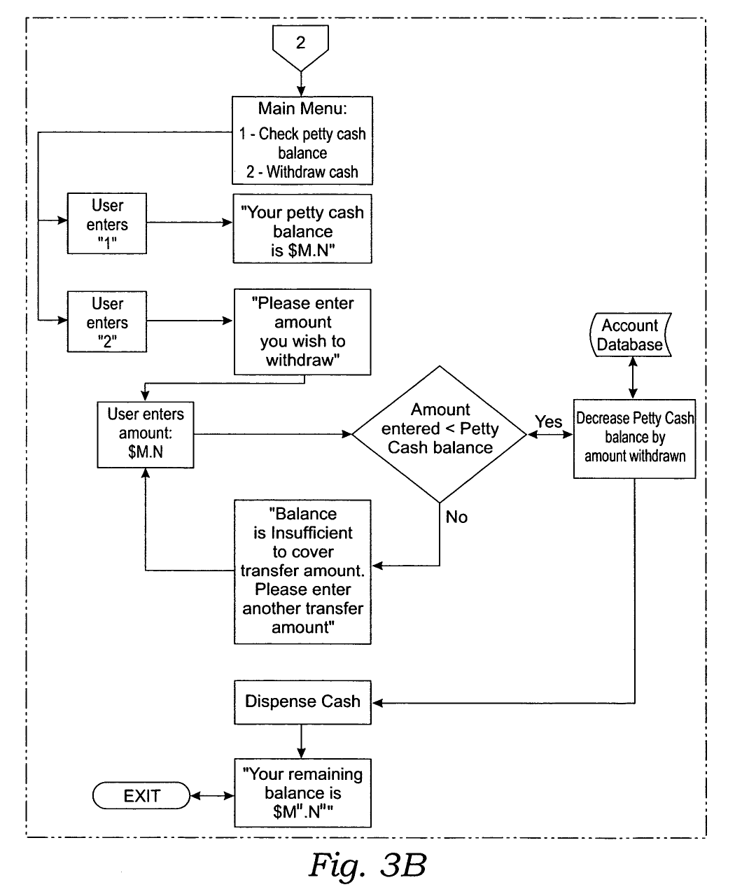

FIGS. 3A and 3B describe a further portion of the present invention whereby a second user is able to obtain cash from the account of the first user. This method includes the steps of identification of the second user at an ATM using an ATM card as described above. The second user's PIN is then keyed-in using the ATM keypad. The second user's PIN is distinct from the first user's PIN so that the second user is not eligible to withdraw funds from the saving, checking or credit line accounts of the first user, but is able to withdraw funds from the petty cash account that the second user's PIN number is set-up for.

The same three-try entry security method is used for the second user as shown in FIG. 3A. In FIG. 3B it is shown that the second user has only two options, to check petty cash balance and to withdraw funds from the petty cash account. These process step are similar to those described above.

In a typical application of the present invention the first user may be in one city while the second user may be in a second distant city, such as would be the case when the parents (first user) of a student (second user) wish to provide cash to the student during the student's time away from home at school. The parents do not wish to maintain a large cash balance that is available to the student for fear of irresponsible behavior on the part of the student. The present method gives the parents full control by enabling them to control the flow of cash into the petty cash account. The student has the flexibility and convenience of access to a flow of cash that will enable the student to meet his or her responsibilities. The student may carry a debit card tied to the petty cash account so that the student is able to use funds in the account without actually receiving cash at an ATM. In a further application of the present invention an earner in the United States, for instance, may set up a petty cash account of the type described above, and a recipient in Mexico, for instance then has access to the account as described. This enables the transfer of funds over significant distances without cost, with the possible exception of currency exchange fees, and with ultimate convenience.

It is noted that the account that funds are to be transferred into or the amount that is taken from the ‘to” account may be any type of monetary form or system including: cash, check, money order, debit card, credit card and pre-paid telephone card wherein the value of the monetary instrument is made equal to or increased by the second sum of money.

The enablements described in detail above are considered novel over the prior art of record and are considered critical to the operation of at least one aspect of one best mode embodiment of the instant invention and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or elements of the embodiments of the herein described invention and its related embodiments not described are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the invention and its various embodiments or that a single element may be substituted for two or more elements in a claim.

Changes from the claimed subject matter as viewed by a person with ordinary skill in the art, now known or later devised, are expressly contemplated as being equivalents within the scope of the invention and its various embodiments. Therefore, obvious substitutions now or later known to one with ordinary skill in the art are defined to be within the scope of the defined elements. The invention and its various embodiments are thus to be understood to include what is specifically illustrated and described above, what is conceptually equivalent, what can be obviously substituted, and also what essentially incorporates the essential idea of the invention.

While the invention has been described with reference to at least one preferred embodiment, it is to be clearly understood by those skilled in the art that the invention is not limited thereto. Rather, the scope of the invention is to be interpreted only in conjunction with the appended claims and it is made clear, here, that the inventor(s) believe that the claimed subject matter is the invention.

What is claimed is:

1. A banking method comprising the steps of: associating a first PIN with a first user; providing the first PIN with full access to a first bank account, and a second bank account; identifying the first PIN to a first automated banking attendant; transferring a first sum of money from the first bank account to the second bank account under the control of the first PIN; associating a second PIN with a second user; providing the second PIN with access to the second bank account for withdrawals only; identifying the second PIN to a second automated banking attendant; and transferring a second sum of money, wherein the second sum of money is equal to or less than the first sum of money, from the second bank account to the second user.

2. The method of claim 1 wherein the transfer of the second sum of money is conducted using a monetary instrument taken from the group of monetary instruments comprising: cash, check, money order, debit card, credit card and pre-paid telephone card wherein the value of the monetary instrument is made equal to or increased by the second sum of money.

3. The method of claim 1 wherein the identifying of the first PIN to the first automated banking attendant, and the transferring of the first sum of money from the first bank account to the second bank account is conducted by one of telephonic and manual data transfer.

4. The method of claim 3 wherein the telephonic data transfer is conducted by one of wire and wireless transmission.

5. The method of claim 4 wherein the wireless transmission is conducted from a cell phone.

6. The method of claim 3 wherein the manual data transfer is conducted using an ATM machine.

7. The method of claim 1 wherein the users have a limited number of tries to enter a valid account number and PIN.

8. The method of claim 1 wherein the users have a choice between receiving information on account balance and transferring funds.

9. The method of claim 1 wherein the first user has a choice as to which first PIN related account is selected for funds transfer.

10. The method of claim 1 wherein the first user has a choice as to the sum of funds transferred.

11. The method of claim 1 wherein the second user has a choice as to the sum of funds to be received wherein the received funds do not exceed the balance available.

12. A banking method comprising the steps of: associating at least one first PIN with at least one first user; providing the at least one first PIN with full access to at least a first bank account, and a second bank account; identifying the at least one first PIN to a first automated banking attendant; transferring a first sum of money from the at least one first bank account to the at least one second bank account under the control of the at least one first PIN; associating a at least one second PIN with at least one second user; providing the at least one second PIN with access to the at least one second bank account for withdrawals only; identifying the at least one second PIN to a second automated banking attendant; and transferring a at least one second sum of money, wherein the at least one second sum of money is equal to or less than the at least one first sum of money, from the at least one second bank account to the at least one second user.

13. The method of claim 12 wherein the transfer of the second sum of money is conducted using a monetary instrument taken from the group of monetary instruments comprising: cash, check, money order, debit card, credit card and pre-paid telephone card wherein the value of the monetary instrument is made equal to or increased by the second sum of money.

14. The method of claim 12 wherein the identifying of the at least one first PIN to the at least one first automated banking attendant, and the transferring of the at least one first sum of money from the at least one first bank account to the at least one second bank account is conducted by one of telephonic and manual data transfer.

15. The method of claim 14 wherein the telephonic data transfer is conducted by at least one of wire and wireless transmission.

16. The method of claim 15 wherein the wireless transmission is conducted from a cell phone.

17. The method of claim 14 wherein the manual data transfer is conducted using an ATM machine.

18. The method of claim 12 wherein the at least one first user has a choice as to which at least one first PIN related account is selected for funds transfer.

19. The method of claim 12 wherein the at least one first user has a choice as to the sum of funds transferred.

20. The method of claim 12 wherein the at least one second user has a choice as to the sum of funds to be received wherein the received funds do not exceed the balance available.
